(19) United States
(12) Patent Application Publication
(10) Pub. No.: US 2017/0322844 A1
(43) Pub. Date: Nov. 9, 2017

(54) SUPER-PARITY BLOCK LAYOUT FOR MULTI-READER DRIVES

(71) Applicant: SEAGATE TECHNOLOGY LLC, Cupertino, CA (US)

(72) Inventors: Eun Yeong Hong, Yongin-si (KR); Woo Sik Kim, Yongin-si (KR); Moweon Lee, Yongin-si (KR)

(21) Appl. No.: 15/150,326

(22) Filed: May 9, 2016

(51) Int. Cl. G06F 11/10; G11B 5/39; G11B 20/18; G11B 5/48; G11B 20/12

(52) U.S. Cl. CPC G06F 11/1076; G11B 20/1833; G11B 5/4886; G11B 5/39; G11B 2020/1238; G11B 2020/1292

(57) ABSTRACT

System, methods, and apparatuses for storing data in a disk-based storage device incorporating multiple readers per recording surface to reduce recovery time from read errors using super-parity. An exemplary storage device comprises a read/write head and an associated recording surface. The read/write head has a plurality of readers configured to read a plurality of data tracks on the associated recording surface concurrently. The recording surface is segmented into a plurality of super blocks comprising a portion of each of a number of adjacent data tracks, the number of adjacent data tracks in each of the plurality of super blocks being equal to the number of the plurality of data tracks that can be read concurrently by the plurality of readers. Each super block further comprises parity information on one of the number of adjacent data tracks containing data recovery information for the super block.

### BRIEF SUMMARY

The present disclosure relates to technologies for storing data in a disk-based storage device incorporating multiple readers per recording surface to reduce recovery time from read errors using super-parity. According to some embodiments, a storage device comprises a read/write head and an associated recording surface. The read/write head has a plurality of readers configured to read a plurality of data tracks on the associated recording surface concurrently. The recording surface is segmented into a plurality of super blocks comprising a portion of each of a number of adjacent data tracks, the number of adjacent data tracks in each of the plurality of super blocks being equal to the number of the plurality of data tracks that can be read concurrently by the plurality of readers. Each super block further comprises parity information on one of the number of adjacent data tracks containing data recovery information for the super block.

According to further embodiments, a method of recovering from an unrecoverable data error in a read operation of a disk-based storage device comprises reading a super block containing a target segment of the read operation, wherein reading the super block is performed in less than one full rotation of the disk. The super block comprises a portion of each of a number of adjacent data tracks on a recording surface of a disk in the storage device. The number of adjacent data tracks in the super block is equal to a number of data tracks that may be read concurrently by a read/write head associated with the recording surface. The super block further comprises parity information on one of the number of adjacent data tracks. The data read from the super block and the parity information is then used to recover data from the target segment.

According to further embodiments, a system comprises a disk comprising a recording surface formatted with a plurality of concentric data tracks, a read/write head associated with the recording surface and comprising a plurality of reader elements and configured to read a plurality of data tracks concurrently, and a controller operably connected to the read/write head. The recording surface is segmented into super blocks comprising a portion of each of a number of data tracks, the number of data tracks in each super block being equal to the number of the plurality of data tracks that are read concurrently by the plurality of reader element. Each super block further comprises parity information on one of the number of data tracks, the parity information comprising data recovery information for the super block. The controller is configured to, upon detecting an unrecoverable data error in a read operation from the disk, read the super block containing a target segment of the read operation, the reading of the super block requiring less than one full rotation of the disk; and use the data read from the super block and the parity information to recover data from the target segment.

These and other features and aspects of the various embodiments will become apparent upon reading the following Detailed Description and reviewing the accompanying drawings.

### BRIEF DESCRIPTION OF THE DRAWINGS

In the following Detailed Description, references are made to the accompanying drawings that form a part hereof, and that show, by way of illustration, specific embodiments or examples. The drawings herein are not drawn to scale. Like numerals represent like elements throughout the several figures.

FIG. 1 is a block diagram showing a conventional layout of super blocks on a recording surface of an HDD for super-parity recovery.

FIG. 2 is a block diagram showing an illustrative layout of super blocks on a recording surface optimized for super-parity recovery in a disk-based storage device incorporating multiple readers per surface, according to embodiments described herein.

FIG. 3 is a block diagram showing an additional illustrative layout of super blocks on a recording surface, according to further embodiments described herein.

FIG. 4 is a block diagram showing an illustrative environment for storing data in a disk-based storage device incorporating multiple readers per recording surface to reduce recovery time from read errors using super-parity, according to embodiments described herein.

FIG. 5 is a flow diagram showing one routine for recovering from an unrecoverable data error in a disk-based storage device using super-parity recovery, according to embodiments described herein.

### DETAILED DESCRIPTION

The following detailed description is directed to technologies for storing data in a disk-based storage device incorporating multiple readers per recording surface, such as a hard-disk drive (“HDD”) device utilizing multi-sensor magnetic recording (“MSMR”) technology, to reduce recovery time from read errors using super-parity. An HDD device may contain one or more disks having magnetic recording surfaces upon which data is stored. The recording surfaces may be formatted to include a number of concentric data tracks, the data tracks further divided into segments or “sectors” in which the user data is stored. The HDD device may further employ a number of devices in the detection/decoding process to allow for recovering data from a bad read. For example, the sectors may include error correction codes (“ECCs”), such as Reed-Solomon error correction codes or low-density parity-check codes (“LDPC”), that allow the data to be recovered from the read sector without requiring additional reads of the recording surface.

If the data cannot be recovered using such devices, an unrecoverable data error (“UDE”) occurs. When a UDE occurs, the HDD device may incorporate other means for recovering the data that require re-reading data from the target sector, the entire data track containing the target sector, and/or adjacent data tracks. One method of recovering from a UDE includes super-parity recovery. Super-parity recovery is often utilized in enterprise-level drives and involves grouping smaller segments or sectors into larger “super blocks” that also include parity information that can be utilized to recover data from the super block.

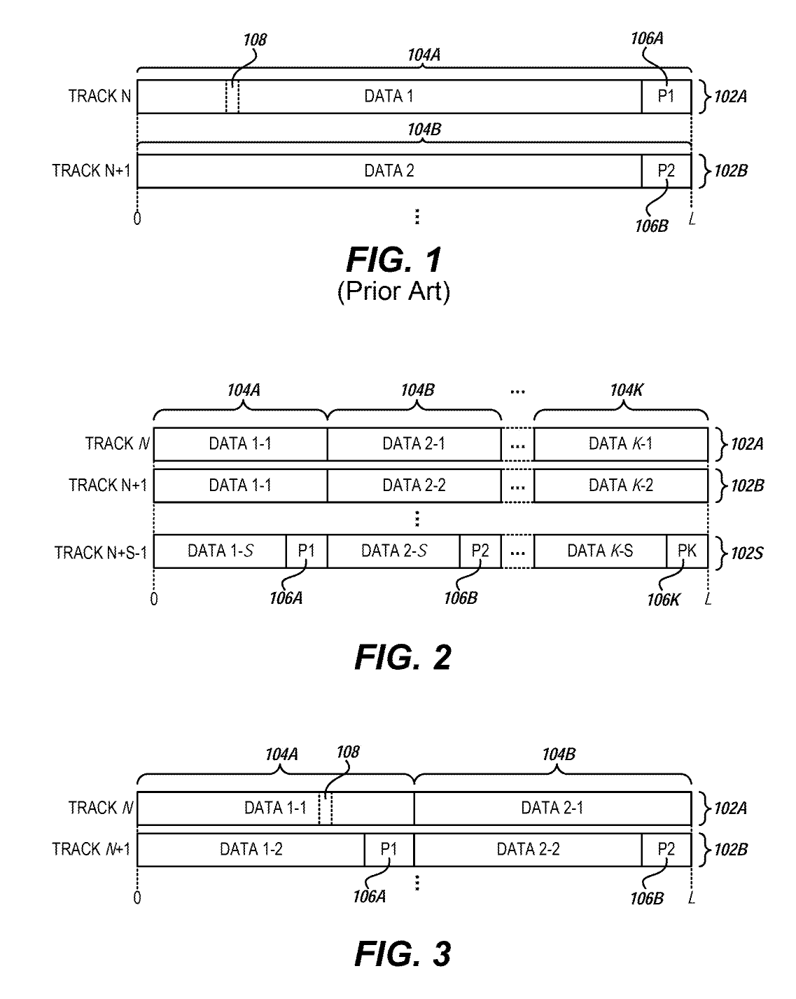

Conventionally, in an HDD incorporating super-parity recovery, the super block comprises a whole data track, with the parity information stored at the end of the track. For example, FIG. 1 shows two data tracks 102A and 102B (referred to herein generally as data tracks 102) on a recording surface of a disk. As shown in the figure, two super blocks 104A and 104B (referred to herein generally as super blocks 104) comprise the entire length L of data track N 102A and data track N+1 102B, respectively. As described above, the super blocks 104 may comprise an aggregation of storage segments or sectors on the data tracks 102, such as sector 108, in which data is stored. In addition, each of the super blocks 104A and 104B include corresponding parity information 106A and 106B (referred to herein generally as parity information 106), respectively. The parity information 106 may be stored at the end of the data track 102, for example.

In the conventional scheme, in order to recover from a UDE in a read of a target sector 108, the controller of the HDD device will read the entire data track 102A containing the sector, including the parity information 106A, and utilize the data read from the track and the parity information to recover the data from the target sector. In an HDD device where the disks rotate at 5400 rpm, it takes at least 11 milliseconds to read the entire length of the data track 102. This means that the time to recover a particular target sector 108 using super-parity cannot be less than 11 milliseconds.

In HDD devices incorporating MSMR, also referred to as two-dimensional magnetic recording (“TDMR”), a plurality of reader elements are associated with each recording surface. Reading data with multiple reader elements improves bit-error rates (“BER”) by allowing the detection/decoding process to account for adjacent track interference (“ATI”), and also allows simultaneous reading of multiple data tracks 102 from the recording surface. According to embodiments, depending on the number of reader elements and their configuration on the read/write head(s), the HDD device may be capable of concurrently reading data from two, three, or more data tracks 102 on the recording surface in a single pass.

According to embodiments presented herein, a novel approach for storing data in super blocks on the recording surface(s) utilizes this characteristic of MSMR technology to allow super-parity recovery from a UDE without requiring a full rotation of the disk. To accomplish this, super blocks 104 are created on the recording surface across a number of data tracks 102 based on the number of data tracks that can be read concurrently by the reader elements associated with the surface. In addition, only a portion of each data track 102 is included in each super block 104. This layout is shown in FIG. 2. According to embodiments, each super block 104A-104K comprises portions of S data tracks, such as data track N 102A through data track N+S−1 102S, where the number S of data tracks in each super block is the same as the number tracks that the reader elements associated with the recording surface are configured to read concurrently. As further shown, each super block 104A-104K takes only a 1/K portion of each data track 102A-102S.

In addition, each super block 104A-104K contains corresponding parity information 106A-106K that can be utilized to recover data from the super block. Because the super blocks comprise only a 1/K portion of the length of the data tracks 102A-102S and span the same number S of data tracks that can be read concurrently by the MSMR drive, it will be appreciated that an entire super block, such as super block 104A, including the corresponding parity information 106A, can be read without requiring an entire revolution of the disk, thus shortening the time required for super-parity recovery over the conventional layout.

In some embodiments, the all of the data tracks 102A-102S comprising each super block 104A-104K are adjacent, such as tracks N through N+S−1 shown in FIG. 2. This may be dependent on the configuration of the reader elements associated with the surface, i.e., whether the reader elements are configured to read adjacent data tracks 102 or tracks spaced apart. In further embodiments the number S of data tracks 102A-102S spanned by each super block is equal to the number K of super blocks 104A-104K partially contained on a data track. For example, according to one embodiment, in a MSMR HDD device having read/write heads with multiple reader elements configured to read S=2 data tracks 102 concurrently, each super block 104A, 104B spans two data tracks, data track N 102A and data track N+1 102B and occupies ½ of the length of the tracks, as shown in FIG. 3.

Because the parity information 106 is maintained for the entire super block 104, and because a super block is distributed into a plurality of data tracks 102, it will be appreciated that all data tracks comprising a super block should be written together in a same write operation in order to maintain the validity of the parity data, according to some embodiments. Accordingly, the novel layout of super blocks 104 described herein may be particularly suited for drives incorporating shingled-magnetic recording (“SMR”). In an HDD device incorporating SMR, write operations are performed in a unit of an SMR band comprising multiple, adjacent data tracks 102. Thus, during an SMR band write, parity information 106A and 106B for super blocks 104A and 104B may be calculated during the writing of data 1-1 and data 2-1 in data track N 102A and temporarily stored. When data 1-2 and data 2-2 for data track N+1 102B is written, calculation of the parity information 106A and 106B may be completed and then written to the data track N+1 to complete the writing of the super blocks 104A and 104B to the disk, as shown in FIG. 3. According to some embodiments, each SMR band is configured to include an integer multiple of S number of data tracks, so that no super block 104 spans two SMR bands on the recording surface.

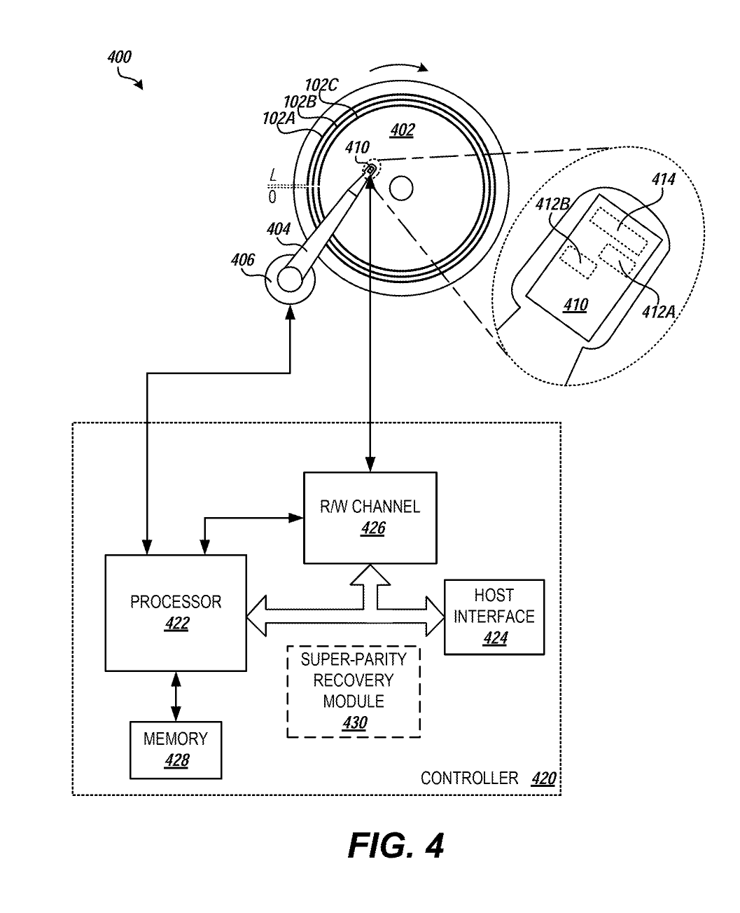

FIG. 4 and the following description are intended to provide a general description of a suitable environment in which the embodiments described herein may be implemented. In particular, FIG. 4 shows an illustrative storage device 400, such as an HDD apparatus, along with hardware, software, and components for storing data to reduce recovery time from read errors using super-parity, according to the embodiments provided herein. The storage device 400 may include recording media comprising at least one platter or disk 402 having a magnetic recording surface. According to embodiments, the recording surface of the disk 402 is divided or “formatted” into a number of individual data tracks, such as data tracks 102A-102C shown in FIG. 4.

The storage device 400 further includes at least one read/write head 410 located adjacent to the surface of each disk 402. The read/write head 410 may read information from the disk 402 by sensing a magnetic field formed on portions of the magnetic recording surface of the disk, and may write information to the disk by magnetizing a portion of the surface of the disk. The read/write head 410 may be located at the distal end of an arm 404 that is rotated by and actuator 406, such as a voice-coil motor (“VCM”), in order to position the read/write head 410 over a portion of the recording surface.

According to embodiments, the read/write head 410 includes multiple reader elements, such as reader elements 412A and 412B (referred to herein generally as reader elements 412). The reader elements 412 may comprise magneto-resistive (“MR”) readers, tunneling MR readers, or the like. In various embodiments, there may be two, three, four, or more reader elements 412 associated with the recording surface of each disk 402 distributed over one or more read/write heads 410, and the reader elements may be configured in width, angle, and position to read two or more data tracks 102 concurrently as the disk 402 is rotated beneath the read/write head(s). For example, as shown in FIG. 4, the read/write head 410 may include two reader elements 412A and 412B offset from one another and configured to simultaneously read two adjacent data tracks, such as data tracks 102A and 102B. It will be appreciated that the size, location, and relative orientation of the reader elements 412 shown in FIG. 4 are for illustrative purposes only, and one of ordinary skill in the art will recognize that other sizes, locations, and relative orientations are possible and part of this disclosure. The read/write head 410 further includes at least one writer element 414. The read/write head 410 may further include other components not shown in the figure or described herein, such as head heaters; temperature sensors; writer shields, micro-actuators, sliders, and the like.

The storage device 400 may further comprise a controller 420 that controls the operations of the storage device. The controller 420 may include a processor 422. The processor 422 may implement a host interface 424 allowing the storage device 400 to communicate with a host device, other parts of storage device 400, or other components, such as a server computer, personal computer (“PC”), laptop, tablet, game console, set-top box or any other electronics device that can be communicatively coupled to the storage device 400 to store and retrieve data from the storage device. The processor 422 may process write operations received from the host device by formatting the associated data and transfer the formatted data via a read/write channel 426 through the read/write head 410 and to the recording surface of the disk 402. The processor 422 may further process read operations from the host device by determining the location of the desired data on the surface of the disk 402, moving the read/write head(s) 410 over the determined location, reading the data from the surface of the disk via the read/write channel 426, correcting any errors and formatting the data for transfer to the host device.

The read/write channel 426 may convert data between the digital signals processed by the processor 422 and the analog signals conducted through the read/write head 410 for reading and writing data to the surface of the disk 402. The analog signals to and from the read/write head 410 may be further processed through a pre-amplifier circuit. The read/write channel 426 may further provide servo data read from the disk 402 to the actuator 406 to position the read/write head 410. The read/write head 410 may be positioned to read or write data to a specific sector 108 on the recording surface of the disk 402 by moving the head radially across the data tracks 102 using the actuator 406 while a motor rotates the disk to bring the target sector under the reader elements 412 and/or writer element 414 or the read/write head.

The controller 420 may further include a computer-readable storage medium or “memory” 428 for storing processor-executable instructions, data structures and other information. The memory 428 may comprise a non-volatile memory, such as read-only memory (“ROM”) and/or FLASH memory, and a random-access memory (“RAM”), such as dynamic random access memory (“DRAM”) or synchronous dynamic random access memory (“SDRAM”). For example, the non-volatile memory and/or the RAM may store a firmware that comprises commands and data necessary for performing the operations of the storage device 400. According to some embodiments, the memory 428 may store processor-executable instructions that, when executed by the processor 422, perform the routine 500 for recovering from a UDE in the storage device using super-parity recovery, as described herein.

In addition to the memory 428, the environment may include other computer-readable media storing program modules, data structures, and other data described herein for storing data in the storage device 400 to reduce recovery time from read errors using super-parity. It will be appreciated by those skilled in the art that computer-readable media can be any available media that may be accessed by the controller 420 or other computing system for the non-transitory storage of information. Computer-readable media includes volatile and non-volatile, removable and non-removable storage media implemented in any method or technology, including, but not limited to, RAM, ROM, erasable programmable ROM (“EPROM”), electrically-erasable programmable ROM (“EEPROM”), FLASH memory or other solid-state memory technology, compact disc ROM (“CD-ROM”), digital versatile disk (“DVD”), high definition DVD (“HD-DVD”), BLU-RAY or other optical storage, magnetic cassettes, magnetic tape, magnetic disk storage or other magnetic storage devices and the like.

In further embodiments, the environment may include a super-parity recovery module 430. The super-parity recovery module 430 may be executed in response to a UDE in a read of a target sector 108 on the disk 402 to recover data for the target sector by reading the encompassing super block 104 and the corresponding parity information 106. According to embodiments, the super-parity recovery module 430 may perform the methods and processes described herein for reducing recovery time from read errors using super-parity in the storage device 400. According to some embodiments, the super-parity recovery module 430 may be implemented in the controller 420 as software, hardware, or any combination of the two. For example, the super-parity recovery module 430 may be stored in the memory 428 as part of the firmware of the storage device 400 and may be executed by the processor 422 for performing the methods and processes described herein. The super-parity recovery module 430 may alternatively or additionally be stored in other computer-readable media accessible by the controller 420. In further embodiments, the super-parity recovery module 430 may be implemented in a computing system external to and operably connected to the storage device 400, such as in a driver module of a host device connected to storage device through the interface 424, for example. The super-parity recovery module 430 may further be stored in a memory or other computer-readable media accessible by the computing system and be executed by a processor of the computing system.

It will be appreciated that the structure and/or functionality of the storage device 400 may be different that that illustrated in FIG. 4 and described herein. For example, the processor 422, read/write channel 426, memory 428 and other components and circuitry of the storage device 400 may be integrated within a common integrated circuit package or distributed among multiple integrated circuit packages. Similarly, the illustrated connection pathways are provided for purposes of illustration and not of limitation, and some components and/or interconnections may be omitted for purposes of clarity. It will be further appreciated that the storage device 400 may not include all of the components shown in FIG. 4, may include other components that are not explicitly shown in FIG. 4 or may utilize an architecture completely different than that shown in FIG. 4.

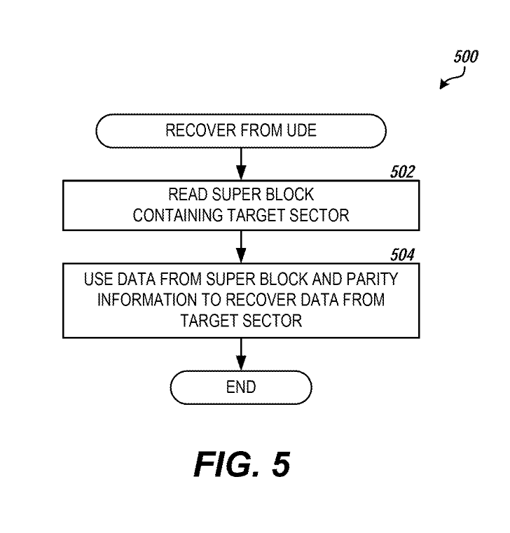

FIG. 5 illustrates one routine 500 for recovering from a UDE in a disk-based storage device 400 incorporating the novel layout of super blocks 104 described herein. According to some embodiments, the routine 500 may be performed by the super-parity recovery module 430 described above in response to a UDE occurring in the read operation of a target sector 108 on the disk 402. In further embodiments, the routine 500 may be performed by the controller 420 of the storage device 400, by external processors or computing systems accessing data from the device or some other combination of modules, processors, and devices.

The routine 500 begins at step 502, where the super-parity recovery module 430 reads the super block 104 containing the target sector 108 in which the UDE has occurred. For example, in an HDD device incorporating MSMR technology with read/write heads 410 configured to read two, adjacent data tracks concurrently, the super-parity recovery module 430 may read the super block 104A, including the corresponding parity information 106A, comprising portions of data track N 102A and data track N+1 102B in a single pass. It will be appreciated that reading of the entire super block 104A with the multi-reader read/write head 410 will require less than a full rotation of the disk 402.

From step 502, the routine 500 proceeds to step 504, where the super-parity recovery module 430 uses the data read from the super block 104A and the corresponding parity information 106A to recover the data from the target sector 108. Because the parity information 106A facilitates recovery of all data in the corresponding super block 104A, the super-parity recovery module 430 may be able to read the encompassing super block and recover the target sector 108 in less time than the disk 402 requires for a full rotation. The data recovered from the target sector 108 can then be returned to the host through the host interface in response to the read operation. From step 504, the routine 500 ends.

Based on the foregoing, it will be appreciated that technologies for storing data in a disk-based storage device incorporating multiple readers per recording surface to reduce recovery time from read errors using super-parity are presented herein. While embodiments are described herein in regard to an HDD device, it will be appreciated that the embodiments described in this disclosure may be utilized in any disk based storage device having the capability to read multiple data tracks concurrently, including but not limited to, a magnetic disk drive, a hybrid magnetic and solid state drive, an optical disk storage device, and the like. The above-described embodiments are merely possible examples of implementations, merely set forth for a clear understanding of the principles of the present disclosure.

The logical operations, functions or steps described herein as part of a method, process or routine may be implemented (1) as a sequence of processor-implemented acts, software modules or portions of code running on a controller or computing system and/or (2) as interconnected machine logic circuits or circuit modules within the controller or computing system. The implementation is a matter of choice dependent on the performance and other requirements of the system. Alternate implementations are included in which operations, functions or steps may not be included or executed at all, may be executed out of order from that shown or discussed, including substantially concurrently or in reverse order, depending on the functionality involved, as would be understood by those reasonably skilled in the art of the present disclosure.

It will be further appreciated that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

Many variations and modifications may be made to the above-described embodiments without departing substantially from the spirit and principles of the present disclosure. Further, the scope of the present disclosure is intended to cover any and all combinations and sub-combinations of all elements, features and aspects discussed above. All such modifications and variations are intended to be included herein within the scope of the present disclosure, and all possible claims to individual aspects or combinations of elements or steps are intended to be supported by the present disclosure.

What is claimed is:

1. A storage device comprising:
a read/write head having a plurality of readers configured to read a plurality of data tracks concurrently; and
a recording surface associated with the read/write head, the recording surface being segmented into a plurality of super blocks comprising a portion of each of a number of adjacent data tracks, the number of adjacent data tracks in each of the plurality of super blocks being equal to the number of the plurality of data tracks that are read concurrently by the plurality of readers, each super block further comprising parity information on one of the number of adjacent data tracks, the parity information containing data recovery information for the super block.

2. The storage device of claim 1, wherein the read/write head is configured to read two data tracks concurrently, and wherein the portion of each of the number of adjacent data tracks comprising the super blocks equals ½ of a total length of the data track.

3. The storage device of claim 1, wherein the recording surface comprises a magnetic surface of a disk, and where the read/write head comprises at least two magneto-resistive (“MR”) reader elements.

4. The storage device of claim 1, wherein the storage device is configured to write data to all adjacent data tracks contained in a super block in a single operation.

5. The storage device of claim 1, wherein the storage device comprises a hard-disk drive (“HDD”) device.

6. The storage device of claim 5, wherein the HDD device is configured to utilize shingled-magnetic recording (“SMR”).

7. The storage device of claim 6, wherein each SMR band is configured to include an integer multiple of the number of adjacent data tracks in each of the plurality of super blocks such that no super block spans two SMR bands on the recording surface.

8. A method of recovering from an unrecoverable data error in a read operation of a disk-based storage device, the method comprising steps of:
reading a super block containing a target segment of the read operation, wherein the super block comprises a portion of each of a number of adjacent data tracks on a recording surface of a disk in the storage device, the number of adjacent data tracks in the super block being equal to a number of data tracks that may be read concurrently by a read/write head associated with the recording surface, the super block further comprising parity information on one of the number of adjacent data tracks; and
using data read from the super block and the parity information to recover data from the target segment, wherein reading the super block is performed in less than one full rotation of the disk.

9. The method of claim 8, wherein the recording surface comprises a magnetic recording surface and the read/write head comprises a plurality of magneto-resistive (“MR”) reader elements.

10. The method of claim 8, wherein the read/write head is configured to read N data tracks concurrently, and wherein the portion of each of the number of adjacent data tracks comprising the super block equals 1/N of a total length of the data track.

11. The method of claim 8, wherein the read/write head comprises two reader elements configured to read 2 data tracks concurrently, and wherein the portion of each of the number of adjacent data tracks comprising the super block equals ½ of a total length of the data track.

12. The method of claim 8, wherein the storage device is configured to write data to all adjacent data tracks contained in the super block in a single operation.

13. The method of claim 8, wherein the storage device is configured to utilize shingled-magnetic recording (“SMR”).

14. The method of claim 13, wherein each SMR band comprises a number of data tracks equal to an integer multiple of the number of adjacent data tracks in the super block.

15. A system comprising:
a disk comprising a recording surface formatted with a plurality of concentric data tracks;
a read/write head associated with the recording surface and comprising a plurality of reader elements and configured to read a plurality of data tracks concurrently, wherein the recording surface is segmented into super blocks comprising a portion of each of a number of data tracks, the number of data tracks in each super block being equal to the number of the plurality of data tracks that are read concurrently by the plurality of reader elements, each super block further comprising parity information on one of the number of data tracks, the parity information comprising data recovery information for the super block; and
a controller operably connected to the read/write head and configured to:
upon detecting an unrecoverable data error in a read operation from the disk, read the super block containing a target segment of the read operation, the reading of the super block requiring less than one full rotation of the disk; and
use data read from the super block and the parity information to recover data from the target segment.

16. The system of claim 15, wherein the number of data tracks comprising each super block are adjacent.

17. The system of claim 15, wherein the read/write head is configured to read two data tracks concurrently, and wherein the portion of each of the number of data tracks comprising the super blocks equals ½ of a total length of the data track.

18. The system of claim 15, wherein the read/write head is configured to read three data tracks concurrently, and wherein the portion of each of the number of data tracks comprising the super blocks equals ⅓ of a total length of the data track.

19. The system of claim 15, wherein the controller is further configured to write data to all data tracks contained in a super block in a single operation.

20. The system of claim 15, wherein the controller is further configured to utilize shingled-magnetic recording (“SMR”).
